(19) United States
(12) Patent Application Publication
(10) Pub. No.: US 2015/0088676 A1
(43) Pub. Date: Mar. 26, 2015

(54) POINT OF SALE NORMALIZATION AND EXTENSION SERVICES

(71) Applicants: Seth Daniel Elliott, Murfreesboro, TN (US); Anthony Ramin Togrye, Murfreesboro, TN (US); Joseph George Peter Natour, Knoxville, TN (US)

(72) Inventors: Seth Daniel Elliott, Murfreesboro, TN (US); Anthony Ramin Togrye, Murfreesboro, TN (US); Joseph George Peter Natour, Knoxville, TN (US)

(21) Appl. No.: 14/038,654

(22) Filed: Sep. 26, 2013

(51) Int. Cl. G06Q 20/20

(52) U.S. Cl. CPC G06Q 20/202
USPC 705/21

(57) ABSTRACT

A method and a device are disclosed including software components that run on a computing device to allow extension of services to customers of a provider of services and/or goods, such as a restaurant. The extension of services include remote pre-selection and pre-ordering of goods and services prior to making contact with a Point Of Sale (POS) by a customer, authorization and/or authentication of users, association of the customer with one of multiple POS via a Quick Response Code (QRC), updating of orders, adaptive learning of order patterns to generate customer profiles, recommendation of goods/services, normalization of data, separate billing for various payers, and the like. The software components provide a set of integrated interfaces for data communication between a customer's computing device, such as a smartphone, and the POS Normalization and Extension Services (POSNES), and between the POSNES and a business having one or more POS.

### CROSS-REFERENCE(S) TO RELATED APPLICATION(S)

This application claims the benefit of the filing date of the U.S. Provisional Patent Application 61748554, filed on 3 Jan. 2013, entitled “POINT OF SALE NORMALIZATION AND EXTENSION APPARATUS,” under 35 U.S.C. §119(e).

### TECHNICAL FIELD

This application relates generally to service coordination. More specifically, this application relates to remote ordering of goods and services using extended services provided by a Point Of Sale Normalization and Extension Services (POSNES) system.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example restaurant environment in which the computing device of FIG. 2 may be used;

FIG. 4 shows example interactions between customer, waiter, and Point Of Sale (POS) in the environment depicted in FIG. 3;

FIG. 5 shows example network-based interactions between multiple POS, customers, and backend Point Of Sale Normalization and Extension Services (POSNES) system;

FIG. 6 shows an example software structure of the POSNES system shown in FIG. 5, suitable for communicating with multiple POS stations; and

FIG. 7 shows an example flow diagram for processing an order of a customer to obtain goods and/or services.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references restaurants, it will be appreciated that the disclosure may be used with other types of services and/or goods a customer may order.

Briefly described, a system and a method are disclosed including software components that run on a computing device to allow extension of services to customers of a provider of services and/or goods, such as a restaurant. In various embodiments, the extension of services include remote pre-selection and pre-ordering of goods and services prior to making contact with a Point Of Sale (POS) by a customer, authorization and/or authentication of users, association of the customer with one of multiple POS via a Quick Response Code (QRC) or other identifier associated with the POS, updating of orders, adaptive learning of order patterns to generate customer profile, recommendation of goods/services to repeating customers based on their profiles at the same or a different POS, normalization of data, invoice management for multiple customers in the same party, separate billing for various payers, and the like, as further described below. The software components provide a set of integrated interfaces for data communication between a customer's computing device, such as a smartphone, and the POSNES, and between the POSNES and a business having one or more POS. Thus, QRC may serve as an identifier for the customer, the associated POS, and the transactions between them.

Typical methods of ordering and paying for food and drinks while dining inside a restaurant at a table or bar consist of two separate interactions: the waiter and a guest interaction and the waiter and point of sale system interaction. The guest orders and pays for their food via the waiter and the waiter then enters the orders and payments into the point of sale system. Thus, guests cannot order or pay for their meals unless the waiter is at the table, thereby limiting the control that the guests have over their dining experience. This often leads to a frustrating experience for the guests, which can limit the tip amount for the waiter and prevent guests from returning due to an unpleasant dining experience.

With the ubiquity of computers and the Internet, an on-line economy has taken root in the recent years, and growing each year in size and scope. Many companies and service establishments, such as restaurants, offer on-line services which are typically a subset of the services offered at their respective points of service. For example, most people are familiar with pizza parlors or restaurants; they are also familiar with calling for home-delivery of pizzas. Some restaurants have on-line selection, ordering, and payment for such home-deliveries. However, most such on-line services are limited to a subset of the services provided at the point of service within the service provider's establishment, such as a restaurant. Some of the offered online services may at most be equivalent to the services offered in person. Offering additional and extended services above what is normally available at a business establishment, such as a restaurant, is highly desirable for both the customers and the businesses.

An apparatus that normalizes and extends standard point of sale system procedures (namely, ordering and payment, and other related services) and delivers this functionality to mobile client software applications is desirable.

### Illustrative Operating Environment

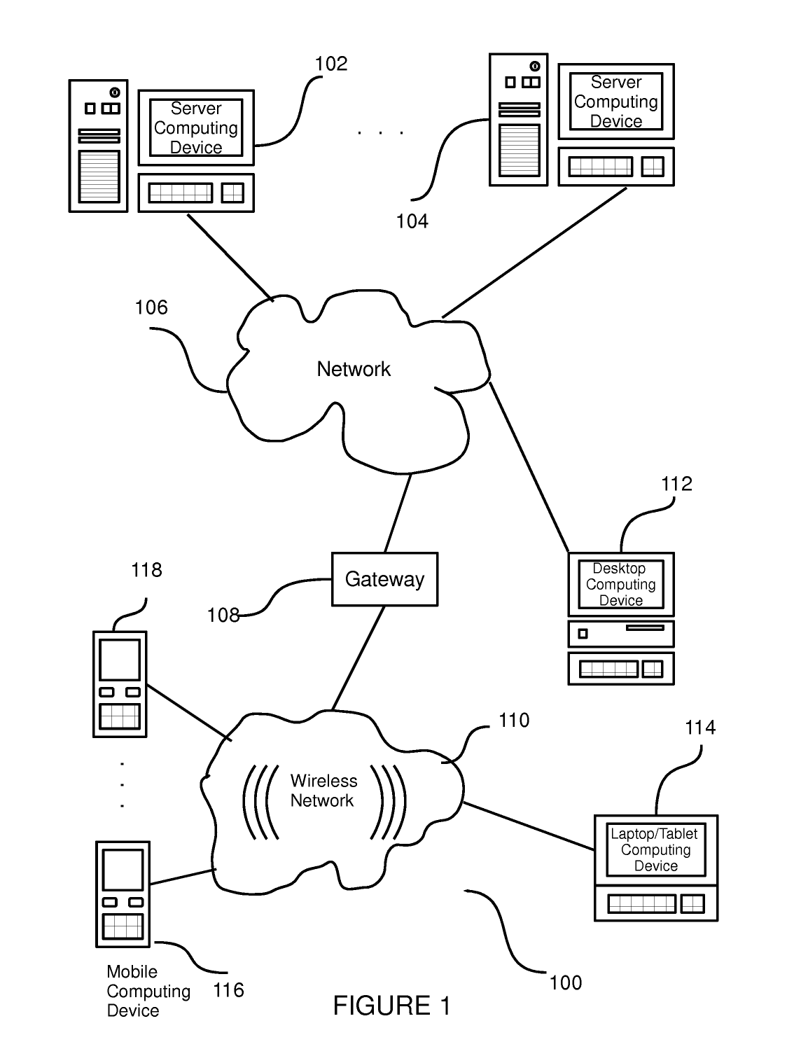

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

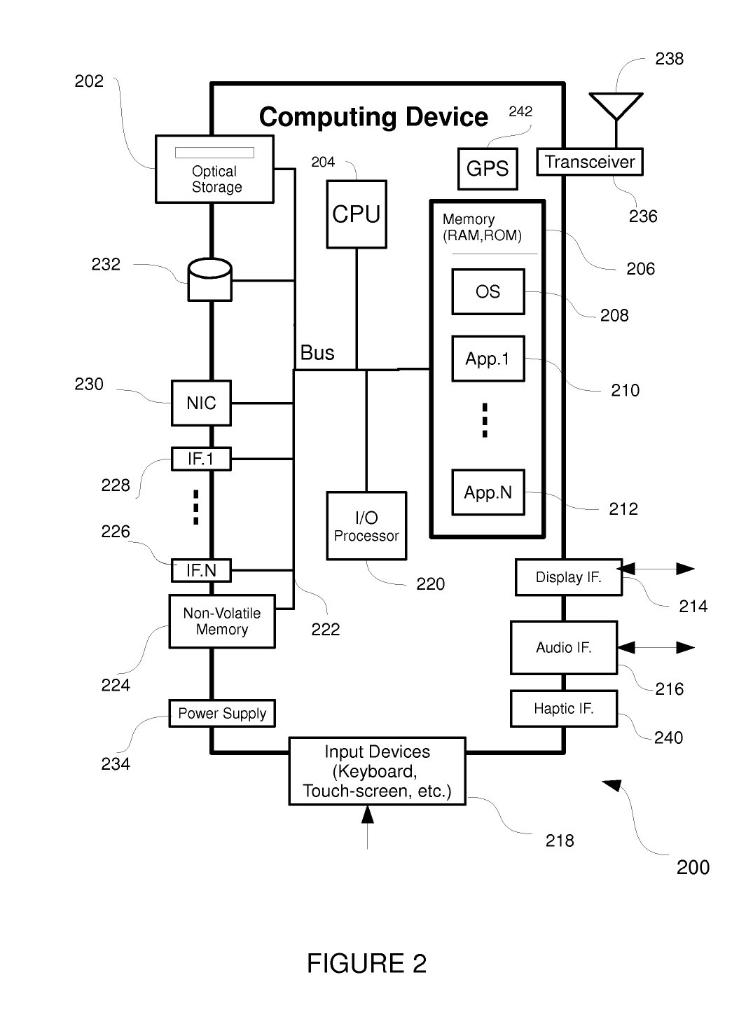

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), Long Term Evolution (LTE), High Speed Packet Access (HSPA+), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

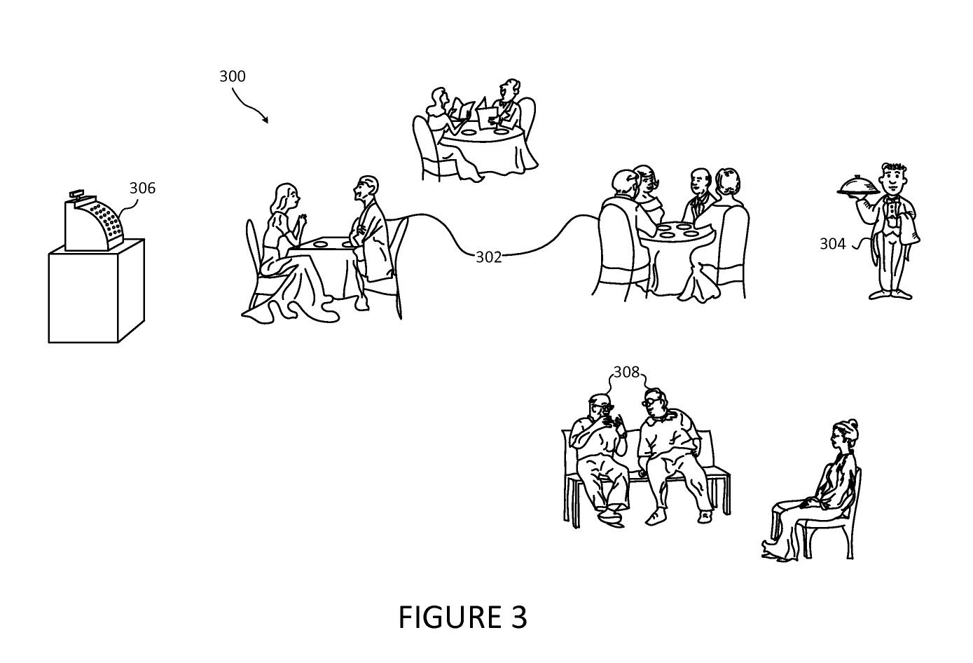

FIG. 3 shows an example restaurant environment in which the computing device of FIG. 2 may be used. In various embodiments, extended services may be offered in a service environment like restaurant environment 300 including patrons or customers 302, service provider staff like waiter 304, Point Of Service (POS) like cash register 306, and customers waiting for service 308.

Typically, in a physical setting, restaurant operation includes customers, service staff, and point of sale financial transactions processing, such as credit card charge handling. Several distinct types of interactions take place in this operation including the interaction between the customer and the waiter, the interaction between the waiter and the POS, and the interaction between the POS and the financial institutions. Additionally, some interactions are implicit in the operation. For example, when a customer physically appears at a restaurant and is seated at a table, he is automatically and implicitly associated with a particular waiter and a particular order, a particular POS or set of POS's. Within one establishment, the same order may be associated with one or more POS. No extra step is needed to associate him with an order or POS. Similarly, the identity of the customer is established in person. However, such implicit interactions need to be explicitly performed when the same or similar services are extended to the online experience. The online experience and the extended services are further described below.

In various embodiments, extended services may include an online version of some of the same interactions in conjunction with other services offered in person. Some of the online services offered may be a preliminary version of the in-person services, while other services may have no in-person counter-part and be extended and new. For example, in a restaurant, an online version food ordering process may start with an “app” (software application on a mobile device such as a smartphone) fetching a menu from a restaurant at which the user or customer intends to dine. The customer may be waiting to be seated and meanwhile can manually or automatically identify the restaurant he is waiting at and download its menu to start the ordering process. He can enter an order for drinks and/or food to be noted and recorded by the restaurant. This way, before the customer is actually seated, his drink can be served while he is waiting. When the customer is seated, his food may already have been prepared and brought to his table shortly afterwards. Service is improved for the customer by faster response, and customer turn-over is increased for the restaurant increasing its revenue by increasing the number of customers served per shift.

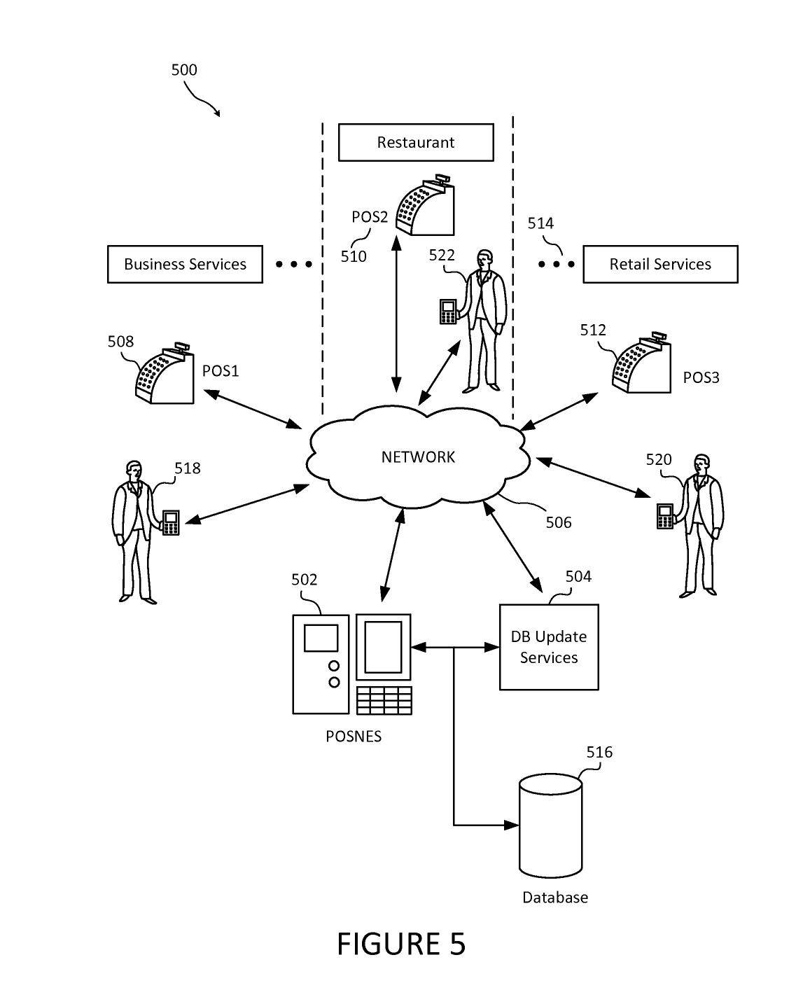

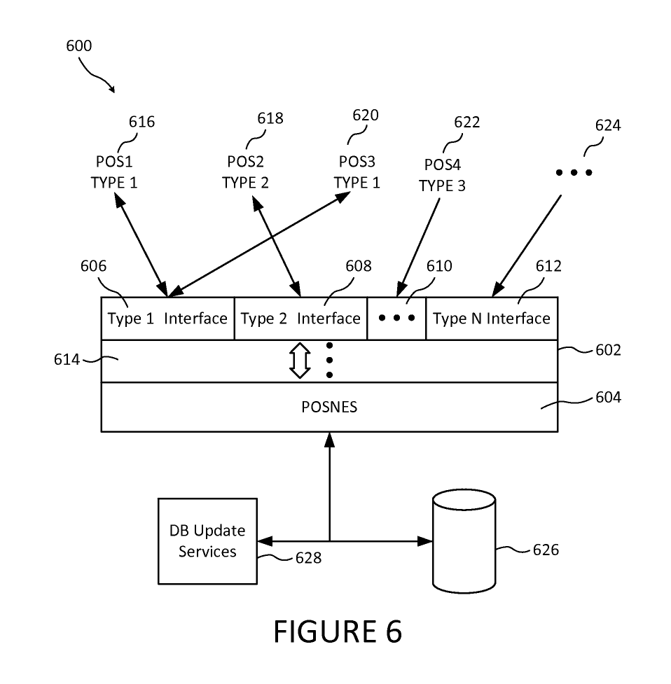

In various embodiments, when the customer starts utilizing online and/or remote extended services, a data record is created in a data storage facility, such as a database to keep track of the customer's transactions, as further described below with respect to FIGS. 5 and 6. The start of such data record may define the start of a customer service session. The customer service session may continue until it is terminated or closed by the payment for the services. Other extended services may be provided in a setting similar to the one described above.

An online and/or remote extended service of pre-selection of goods and services prior to making contact with a Point Of Sale (POS) by a customer, may be made by obtaining a list, catalog, or menu of such goods or services to review and select from. such data may be obtained by downloading them from the service provider's website or other computing facility. Such data may also have been pre-stored on the customer's computing device, such as a smartphone or a tablet. The data may also be obtained from a third party data provider.

Another online and/or remote extended service is the pre-ordering of goods and services selected as described above. For example, in a restaurant setting, the customer may pre-order drinks, appetizers, and/or food before he is actually seated for service. The pre-ordering may be done while the customer is waiting to be seated in a crowded restaurant.

Before the customer can order goods and services, however, his financial credentials may need to be authenticated and/or authorized to avoid unnecessary expenditure of time and resources on the part of the merchant or service provider to prepare the goods or services ordered in the event the customer's credentials cannot be authenticated. Authentication is the verification of the identity of an actor such as the customer and/or his computing device, while authorization is securing the permission of the user to take a particular action, such as charging a credit card. Such remote authentication/authorization is another extended service, which may entail more steps and details than when done in person.

In addition to the authentication and authorization, the customer and/or his computing device may first have to be associated with a POS in the business establishment. A single business establishment may included a single or multiple points of sale. The association with a POS may be performed using a Quick Response Code (QRC) pre-assigned to a POS or a table at the restaurant, a Globally Unique IDentification (GUID), an ID derived based on GPS coordinates, or other techniques for identification of a customer and/or his computing device. This association is akin to assigning or pre-assigning a waiter or a table to the customer in a physical setting. This association is performed to determine where to place the order, where and how to pay, and who to make responsible for providing the service to the customer. This is further discussed below with respect to FIGS. 5 and 6.

Another extended service is updating of services or corresponding transactions in a data record initially created. For example, the user may have initially ordered a drink while waiting. This order is added to the customer's service record for his current service session. He may later order an appetizer using the extended services. The appetizer needs to be added to the data record to update the session data.

Still another extended service is adaptive learning of the preferences and/or profile of the customer. The customer's profile may be built over multiple sessions to indicate the customer's preferences, purchase patterns, favorite foods or services, preferred payment method, and the like. The profile may later be used to recommend new products, goods, and services to the customer in future sessions at the same or a different service establishment. Such recommendations increase customer loyalty due to personalized service and quicker response times. For example, a customer's favorite drink or appetizer may be pre-ordered for the customer, subject to his approval, upon the start of a new session.

Another extended service is the sharing of customer ratings, reviews, opinions, and comments with other customers via social networks, such as Facebook®, the client application, and/or the web page used as client-side interface.

Another extended service is the exposure of the customer, via social networks, the client application, and/or the web page used as client-side interface, to advertisements which may provide valuable information about products and services the user may be interested in. Such advertisements may be based on the user profile and preferences built up from the user's selections and transactions. For example, a user who most of the time orders bottled water with his food instead of soft drinks, may be health conscious, and thus health related advertisements, such as sports equipment or other healthful foods, may be presented to him.

Another extended service is normalization of data. Normalization is technique in database management for reducing or eliminating data redundancy. In a database, multiple data items may be entered about the same entity, such as a person, a project, a business, or the like, with redundant information. For example, each time the name of a person is entered on a charge record, his address, phone number, and other information may also be entered. Such data are already in the database and thus, reentering this data is wasteful of time and storage space and can also result in conflicting information or other informational anomalies if different values are entered for the same information, such as a new phone number or address. Normalization includes designing a database with small inter-related tables with few dependencies. The purpose of this design is to isolate data so that additions, deletions, and modifications of a field can be made in just one table and then be used by the rest of the database using the relationships between the various tables. A number of normalization techniques are recognized such as the First Normal Form (1NF), the Second Normal Form (2NF), and the Third Normal Form (3NF). Typically, a relational database table is considered normalized if it is in 3NF, which are mostly free of insertion, update, and deletion anomalies.

Invoice management for multiple customers in the same party is another extended service. In a restaurant setting, as several customers in the same party add items to their order, the same POS associated with their dining table may be associated with the several customers. As such, keeping track of their orders automatically for billing purposes may be a valuable service for the efficient operation of the restaurant and also improve the service to the customers by providing faster service and reduced errors in splitting checks. The orders by each customer may be added to their billing history in the database, be used for updating their preferences and profiles, and help in providing more customized service.

Those skilled in the art will appreciate that other extended services not explicitly mentioned here may be offered without departing from the spirit of the present disclosure. For example, an online report of a customer's purchase history by date, location, time, and the like, may be provided as an extended service to customer for tax purposes, review of expenditure, and the like.

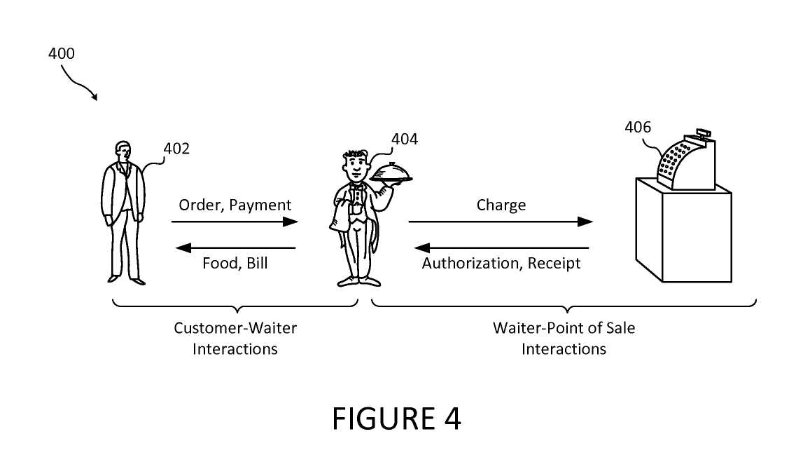

FIG. 4 shows example interactions between customer, waiter, and Point Of Sale (POS) in the environment depicted in FIG. 3. In various embodiments, the interactions 400 within a service establishment, such as a restaurant, may be broadly categorized as those between a customer 402 and a waiter 404, and between the waiter 404 and point-of-sale, such as cash register 406.

As further described below with respect to FIGS. 5 and 6, aspects of these interactions or extended versions of them may be performed automatically as extended services online.

FIG. 5 shows example network-based interactions between multiple POS, customers, and backend Point Of Sale Normalization and Extension Services (POSNES) system. In an online commercial environment 500, POSNES system 502 may be coupled with a database 504. In an online commercial environment 500, POSNES system 502 may be coupled with a database update service 504, a database 516, a network 506, multiple POS 508, 510, 512, 514 associated with customers 518, 520, and 522, and representing various businesses, restaurants, and retail establishments.

In various embodiments, POSNES system 502 may be implemented by a hardware and/or software system using one or more software components executing on the illustrative computing device of FIG. 2. One or more functions, such as those described above with respect to FIG. 3, may be performed by each one or more software module recorded on a medium such as an optical disk, magnetic tape, volatile or non-volatile computer memory, and the like, or transmitted by various communication techniques using various network and/or communication protocols, as described above with respect to FIG. 1.

In various embodiments, one or more separate software components may be used for each of the functions for pre-selection and pre-ordering of goods and services prior to making contact with a POS by a customer, authorization and/or authentication of users, association of the customer with one of multiple POS via a quick response identifier associated with the POS, updating of orders, adaptive learning of customer profile and order patterns, recommendation of goods/services to repeating customers based on their profiles at the same or a different POS, normalization of data, invoice management for multiple customers in the same party, separate billing for various payers, and the like described herein. For example, an order processing software module may receive customer orders, while an authorization software module may verify the identity and authority of the customer to place an order and charge it to a credit card. Similarly, other software modules may be employed to perform pre-defined functions such as those described above with respect to FIG. 3.

Those skilled in the art will appreciate that one function may implemented using multiple software modules or several functions may be implemented using one software module. With further reference to FIG. 2, these software modules are generally loaded into the memory module 206 of the computing device for execution.

In various embodiments, the POSNES forms the server side of a client-server computing model. The client side may be a software application running on the customer's computing device, such as a smartphone app. Alternatively, the client-side software module may be a web browser loading webpages provided by a web server on the POSNES side. In various embodiments, the user interface provided by the client side of the POSNES system may include a messaging area for POSNES recommendations for other food and drinks, order status information, wait time to be seated at a table, running total of the customer's bill so far in the customer session, and the like. The client-side user interface may also have other software GUI (Graphical User Interface) components such as buttons, drop down lists, menus, hotlinks, and the like, for scanning QRC or other identifier, selecting items for ordering, editing or changing orders, requesting special accommodations, selecting tables, and the like.

In various embodiments, software modules on both the client and the server side may be employed to communicate and send and receive data between the client and the server sides. The data transmitted may include customer orders, menu listing, recommendations, billing and payment information, and generally any other data or information needed in the operation of the POSNES and the POS in serving the customer.

In various embodiments, to use the POSNES apparatus, a user may install a compatible client application on their mobile device. A client application is any software capable of interfacing with the POSNES system via its defined communication protocols. The main purpose of such client application is to deliver POSNES system functionality to a user's device. On the commercial side, the POSNES system interface software may also have been installed on the POS in a particular establishment, such as a restaurant, such that the POSNES system is in communication with the restaurant's POS.

Those skilled in the art will appreciate that the interactions between the customer/user, the POS, and the POSNES system may take various forms. One form of such interactions is described below. In various embodiments, the POSNES may be responsible for accepting normalized requests from the client application, forming POS requests specific to the authorized POS system, parsing the response, and returning a normalized response to the client application. Before the ordering, payment, and other POS operations services offered by the client application can be used, a user may first have to be authorized to order on and pay for their check at the restaurant. This may be done by submitting authorization information (for example, access codes, passwords, GPS coordinates, etc.) of the requesting mobile application to the POSNES (or indirectly through the associated POS). The POSNES system may either accept or reject the credentials, and send the appropriate response back to the client application. If the credentials are rejected, the user is denied authorization to make requests to the POSNES. Once authorized, the user of the application may use the application to order at the restaurant or submit payment for his or her meal. Regardless of the type of request (POS operations [e.g., ordering and payment] or extension [e.g., get restaurant menu]), the application forms a request then sends it over a network to the POSNES.

If the request is an extended service request, the POSNES processes the request and then sends the response data and/or indicators of success or failure back to the app. If the request is a POS operation request, POSNES first decides which POS system needs to be queried and what type of POS system it is. This information is stored in the database component, thus the POSNES subsequently queries and retrieves this information from the database. Using this new POS system specific information, the POSNES forms the respective requests and forwards it over the network to the POS system in question. The POS system parses the request and sends a response back to the POSNES. The POSNES then parses the response for indicators of success or failure, updates the Database with the response, and then forms a normalized response, which it sends back to the client application.

In various embodiments, multiple POS from different geographic locations, may communicate with the POSNES system. In operation, user 518 may be associated with POS1 508 via the user's computing device such as a tablet or a smartphone using a Quick Response Code (QRC). The QRC may be a barcode, a number, an image, a hologram, or other suitable identifier associated with a customer station, such as a table in a restaurant, that may be scanned with a smartphone to start the process of using the extended and/or online services offered by a commercial establishment. In some embodiments, the QRC may be a locally unique (within the business establishment) identifier, while in other embodiments, the QRC may be a Globally Unique ID (GUID) generated based on one or a combination of time-stamp, location, device name, network ID, a customer session ID, and the like.

Once the QRC is scanned by the customer, it may be used in all subsequent transactions in the present customer session to distinguish the customer from other customers. The QRC may pre-associated with a particular POS or may be used to associate the customer with the POS to track further orders, authorizations, payments, order updates, and the like. For example, if the customer orders an appetizer, the order is associated with a particular POS, assigned to a waiter to deliver the appetizer, and added to the customer's bill.

In various embodiments, if a user desires to order from a waiter at a restaurant instead of using their mobile device, such as a smartphone, the waiter may input the order into the one or more POS directly, which are in communication with the POSNES system. The order inputted into the one or more point of sale systems may be transmitted to the database update module and stored in the appropriate table of the database, such as a food ordering and payment table. The order inputted may also be transmitted to the user's device such that the order appears on the device and the user may pay for the order on the device. This allows a user to place an order using an ordering device when the user desires to make an order, and further allows the user to pay for the order when the user desires to pay for the order. Thus, the POSNES system provides flexibility by allowing the user to place additional orders from a waiter and having those orders incorporated into the order placed on the ordering device. This way, all related data remain consistent and synchronized both on the user's device and on POSNES system.

In various embodiments, a permanent record for each customer may be created based on the customer's name, address, phone, or other unique or rare information and be maintained indefinitely to serve the customer in different sessions as the customer comes back for various services at the same or a different POS. The customer record and profile is updated during each session to keep accurate information about his preferences for particular services. In other embodiments, the customer record is created and persists only during the current customer session and is deleted afterwards.

With continued reference to FIG. 5, in various embodiments, some of the processing of customer orders based on QRC may be performed locally in a software module deployed at the local POS, or all data may be collected by a customer device software module, such as a mobile app running on a smartphone, and transmitted to the POSNES via network 506 for recordation and processing. In some embodiments, the POSNES may be in communication with various POS for handling the orders of their respective customers. Order handling may include some or all of the extended services described above. It may also include handling the financial transactions such as authorization of credit cards, charging of credit card balance, and automatic debit from customer's account via commercial facilities such as Automated Clearing House (ACH) networks.

In various embodiments, the database update service 504 may be implemented as a separate server or a separate software module to update the database as new orders come in or as existing customer orders or bills are updated due to additional orders placed by the customer. For example, normalization may be one of the functions performed by the DB update service 504. One of the functions of the update service is to synchronize the POS system and the database. Specifically, the synchronization at least entails ensuring that the database reflects any changes that the POSNES did not itself generate. For instance, a user might use his or her waiter (not through the mobile/client application) in the restaurant to order another drink. At this point, the database contains no record of the new drink having ever been ordered, because it was not ordered via the client application. Thus, there is a need for the database to have a normalized record of this transaction. The database update system may receive requests from the POS system that contain the information needed for updating the database, such as changing, adding, or deleting records or data items. The database update system may then query the appropriate database tables to make these changes. Once the changes are made, or if an error occurs, the database update system notifies the POS system indicating success or failure. Those skilled in the art will appreciate that some or all of the database interactions may be performed by other software modules such as a database interface module of the POSNET system without departing from the spirit of the present disclosure.

Examples of a Point Of Sales (POS) system include systems made by companies such as Micros Systems, NCR (commonly known as Aloha), POSitouch, Squirrel, Future, and Focus. The interactions between the POS and the database update system and/or the POSNES system may be either synchronous or asynchronous. The POS may notify the database update system that an update is needed via a request. The update system may then process this request and return success or failure as the result. In the event of a failure, the event may be logged and administrator of the POSNES system may be notified. In a synchronous update environment, the POS process can be configured to terminate on failure, but the default action may be to warn and continue.

Using POSNES, POS, DB update service, and the network to handle some aspects of the customer's orders, the transactions between the customer and the waiter and also between the waiter and the POS are enhanced and overall performance is improved for the customer and the business. This way, the customer has more control over the timing of his order and also has more visibility to the status of his order.

In various embodiments, in a restaurant setting, when the customer scans the QRC to start his order, POSNES may recommend and/or pre-order, subject to customer's final approval, some of the customer's favorite foods or drinks according to his profile built over the course of his previous orders. Such recommendations may be in the form of a message to the customer via the client-side software, described above.

FIG. 6 shows an example software structure of the POSES system shown in FIG. 5, suitable for communicating with multiple POS stations. In various embodiments, software structure 600 includes multiple layers of software 602 having a base POSNES layer 604, middle layers, 614, and specific POS layer with multiple interface adapters 606-612 corresponding to POS types 616-624, DB update service module 628, and database 626.

In various embodiments, POSNES has a layered software structure, which allows the same functional modules in the base layer 604 work with multiple POS types. Software interface adapters or middle layers are used for this purpose. A software interface layer, such as 606, 608, 610, and 612 interface adapters, are designed to communicate with a particular type of POS and the appropriate data formats Like a communication stack, an interface adapter takes the data format from one of its sides and converts it to the format the other side can understand or process. For example, if POS1 616 and POS3 620 are of a particular type, such as type1, then interface adapter 606, designed for type1 POS communications, can take data from POS1 and POS3, convert the format to a standard form that can be processed by POSNES layer 604, and pass the data on to the POSNES layer for processing. Similarly, POSNES can pass the data intended for POS1 or POS3 through interface adapter 606 to be converted to a format which can be processed by POS1 and POS3. This way, to add a new POS type, only a new interface adapter needs to be added rather than having to redesign the whole software stack for each new POS type.

In various embodiments, the base layer or functional POSNES layer 604 may implement core functionality such as QRC processing, authorization, profile management, database update, and the like, as described above. Those skilled in the art will appreciate that the selection of the software structure, number of layers, interfaces, protocols, and other software facilities may vary based on needs or requirements such as flexibility, security, maintenance, cost, third party software integration requirements, and many other factors, without departing from the spirit of the present disclosure.

In various embodiments, depending on design criteria, security requirements, cost considerations, access availability and the like, the DB update service module 628 may be coupled with each POS through POSNES (as shown in FIG. 6), while in other embodiments, it may be coupled with each POS through interface adapters 606-612 and also be coupled with the POSNES separately.

Using the software structure described above may provide a standard interface between POSNES and various POS types. Additionally, the client application may provide the users with a standard and consistent user interface for ordering various goods and services at different establishments and points of sales.

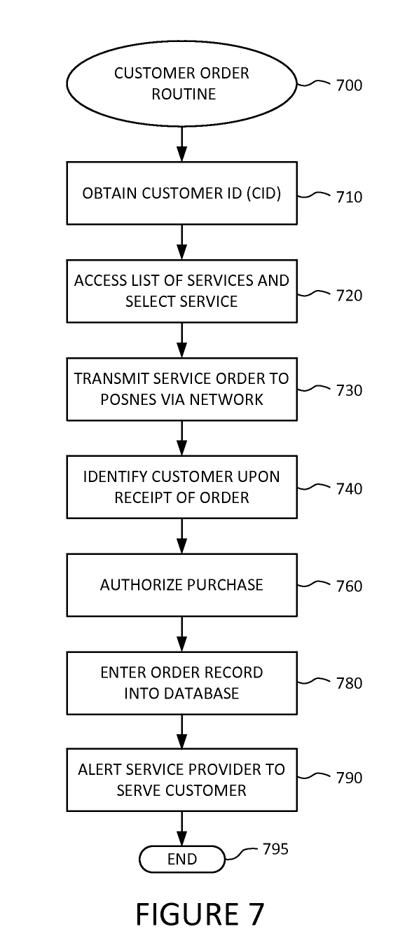

FIG. 7 shows an example flow diagram for processing an order of a customer to obtain goods and/or services. In various embodiments, customer order routine 700 proceeds to block 710 to obtain a customer identification. In various embodiments, the customer identification may or may not be a personal identification. A customer identification may be based on a QRC scanned by the customer when he enters a commercial establishment such as a restaurant. For example, a restaurant may have a list of QRC near the entrance for scanning, a QRC on each table, or a QRC dispenser. The QRC may be a number, a barcode, a GUID, an image, or any other symbol that may be used to distinguish one customer from another and be able to track his orders. This way the QRC scanned by the customer and the customer himself may be associated with a POS for the present customer session, during which the customer may order various goods and services and be served by the establishment accordingly.

In some embodiments, a customer session may not exist or may be simple having a single round of orders. In these embodiments, once an order is given and paid for, the customer session ends automatically and there is little need for session management, billing, order update, and the like. For example, in a fast-food restaurant a person may order a hamburger and a drink and pay for it. In these embodiments, the customer identifier may be appended with an indicator to indicate a simple customer session and preclude other extended services. The routine proceeds to block 720.

At block 720, the customer may access a list of goods or services such as a menu for food and drink items. The service list may be downloaded by the app running on the customer's computing device, such as a tablet or a smartphone, it may be presented on a webpage downloaded from a web server, or may be preloaded by the app, among other access options. The customer may choose one or more items from the list and order the items. The routine proceeds to block 730.

At block 730, the customer order is transmitted via network by the client application for service. In various embodiments, the order may be transmitted to the POS now associated with the customer based on the QRC. The POS receives the order, performs any local processing, such as verifying the validity or availability of the items ordered, hours of operation of the restaurant for accepting new orders, and any other functions or services assigned to POS and then transmits the order to POSNES system for further processing. In other embodiments, the order may be transmitted directly to the POSNES system. The POSNES system may then communicate with the associated POS to validate the order, provide the services, or other services and functions to be performed by POS as needed. The QRC may be included in all communications and transactions between the customer, the POS, and the POSNES system for order tracking. The routine moves to block 740.

At block 740, the associated POS or the POSNES system identifies the customer at least based on the QRC to create and/or update the data records of the customer in the databases. For a first time customer, a new record may be created and updated as the customer orders new items. For a repeat customer, the existing data records for the customer are updated according to the new orders. The routine proceeds to block 760.

At block 760, the customer order is authenticated and authorized. Authentication is the process of verifying the customer's identity and authorization is the process of securing the customer's permission to charge his account, credit, debit, or otherwise, to pay for his orders. Authentication and authorization are generally performed by obtaining and verifying confidential information such as credit card number, billing address, account number, postal zip code, Personal Identification Number (PIN) for debit accounts, and the like, that usually only the customer knows. The routine proceeds to block 780.

At block 780, the order is processed and the corresponding data are entered into the service record created for the customer. If other information are already in the database for the same session, the records are updated to reflect the current status of the customer order. The status information may include the items ordered, the corresponding charges, the name or ID of the serving staff, the POS ID, timestamp for each order or transaction, seating status, billing status, payment information, and the like. Those skilled in the art will appreciate that many other information may be entered into the data record without departing from the spirit of the present disclosure. For example, information about his previous customer sessions, preferences, and the like. The routine proceeds to block 790.

At block 790, a notification or alert may be sent by the POSNES to the servicing staff, such as waiters to serve the customer, for example, by delivering the customer's ordered items to where the customer is waiting to be seated. In various embodiments, such notification may come locally from the associated POS, or it may originate from the POSNES and then come through the POS to local staff. The routine proceeds to block 795 and terminates.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the disclosure.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware based systems which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A Point Of Sale (POS) Normalization and Extended Services (POSNES) system, the system comprising:
a server computing device in communication with a client computing device of a customer;
an order processing module associated with the server computing device and configured to process customer orders presented by the client computing device, and further configured to associate the customer with a POS to allow the customer to order services directly from the POS; and
a database coupled with the server computing device and configured to store information about the customer orders.

2. The system of claim 1, further comprising a database update module.

3. The system of claim 1, wherein the server computing device includes software modules that when executed cause the server computing device to perform extended services including at least one of pre-selection and pre-ordering of goods and services, authorization and authentication of the customer, association of the customer with one of multiple POS, updating of customer orders, adaptive learning of the customer order patterns, generating of a customer profile, recommendation of goods and services to the customer based on his profile at the same or a different POS, normalization of data in the database, and invoice management for multiple customers in one party.

4. The system of claim 1, wherein the client computing device is one of a smartphone and a tablet device.

5. The system of claim 1, wherein the customer order is obtained by a software module running on the client computing device.

6. The system of claim 1, wherein the client computing device includes a software module for scanning a Quick Response Code (QRC).

7. The system of claim 1, wherein a database update module is configured to update the database with customer orders sent via the client computing device to the POSNES and customer orders given otherwise.

8. The system of claim 1, wherein the POS is in a restaurant.

9. A method of extending Point Of Sale (POS) services, the method comprising:
receiving a customer order from a client computing device of a customer;
using an order processing module associated with a server computing device, in communication with the client computing device, to process the customer order and to associate the customer with a POS to allow the customer to order services directly from the POS; and
storing, in a database coupled with the server computing device, information about the customer order.

10. The method of claim 9, further comprising scanning a Quick Response Code (QRC) by the client computing device.

11. The method of claim 9, wherein the customer order is based on a list of goods and services obtained by the client computing device.

12. The method of claim 9, wherein the server computing device includes software modules that when executed cause the server computing device to perform extended services including at least one of pre-selection and pre-ordering of goods and services, authorization and authentication of the customer, association of the customer with one of multiple POS, updating of customer orders, adaptive learning of the customer order patterns, generating of a customer profile, recommendation of goods and services to the customer based on his profile at the same or a different POS, normalization of data in the database, and invoice management for multiple customers in one party.

13. The method of claim 9, wherein the POS is one of multiple POS systems within a commercial establishment.

14. The method of claim 9, further comprising generating a customer profile based on the information about the customer order.

15. The method of claim 9, wherein using an order processing module comprises communicating with a mobile software application to interact with the customer.

16. A method of customer order processing, the method comprising:
receiving a customer order from a client computing device of a customer;
associating the customer with a POS to allow the customer to order services directly from the POS;
offering extended services to the customer, wherein the extended services are different from order processing and billing; and
storing, in a database coupled with the server computing device, information about the customer order based on which a customer profile is generated.

17. The method of claim 16, further comprising downloading a menu of goods and services.

18. The method of claim 16, further comprising scanning a Quick Response Code (QRC) to identify the customer and the POS in communications.

19. The method of claim 16, wherein associating the customer with the POS comprises converting data formats from different POS types to a standard format usable by data processing modules.

20. The method of claim 16, wherein the extended services include at least one of pre-selection and pre-ordering of goods and services, authorization and authentication of the customer, association of the customer with one of multiple POS, updating of customer orders, adaptive learning of the customer order patterns, generating of a customer profile, recommendation of goods and services to the customer based on his profile at the same or a different POS, normalization of data in the database, and invoice management for multiple customers in one party.
